(19) United States
(12) Patent Application Publication
(10) Pub. No.: US 2014/0267292 A1
(43) Pub. Date: Sep. 18, 2014

(54) SEQUENCED GRAPH VISUALIZATION

(71) Applicant: Alexander Ioffe, Palo Alto, CA (US)

(72) Inventor: Alexander Ioffe, Palo Alto, CA (US)

(21) Appl. No.: 13/892,256

(22) Filed: May 11, 2013

Related U.S. Application Data
(60) Provisional application No. 61/792,408, filed on Mar. 15, 2013.

(51) Int. Cl. G06T 11/20

(52) U.S. Cl. CPC G06T 11/206
USPC 345/440

(57) ABSTRACT

Systems and methods for generating a sequenced graph visualization are provided. In some aspects, a representation of a sequenced graph is received. The representation includes a set of graph components, where each graph component is associated with at least one sequence counter from among multiple sequence counters. A graph visualization is generated, for each sequence counter from among the multiple sequence counters, where the graph visualization for a specific sequence counter includes graph components associated with the specific sequence counter, and where the graph visualization for the specific sequence counter blurs, obfuscates, or lacks graph components not associated with the specific sequence counter. The generated graph visualization for each sequence counter from among the multiple sequence counters is stored in a memory.

### CROSS REFERENCE TO RELATED APPLICATION

This application claims priority under 35 U.S. C. §119(e) and the benefit of U.S. Provisional Application No. 61/792,408, filed Mar. 15, 2013, and entitled, “SEQUENCED GRAPH VISUALIZATION,” the entire disclosure of which is incorporated herein by reference.

### BACKGROUND

The subject technology generally relates to graphing applications and, in particular, relates to generating sequenced graph visualizations.

A slideshow application may allow a user to design multiple slides, where each slide includes different content. Similarly, a graphing or computer-aided design (CAD) application may allow the user to design multiple graphs or charts, where each graph or chart includes different content. However, the slideshow, graphing, or CAD applications may not be useful for designing or presenting certain types of graphs.

### SUMMARY

In some aspects, the disclosed subject matter relates to a computer-implemented method for generating a sequenced graph visualization. The method includes receiving a representation of a sequenced graph. The representation includes a set of graph components, where each graph component is associated with at least one sequence counter from among multiple sequence counters. The method includes generating, for each sequence counter from among the multiple sequence counters, a graph visualization, where the graph visualization for a specific sequence counter includes graph components associated with the specific sequence counter, and where the graph visualization for the specific sequence counter blurs, obfuscates, or lacks graph components not associated with the specific sequence counter. The method includes storing, in a memory, the generated graph visualization for each sequence counter from among the multiple sequence counters.

In some aspects, the disclosed subject matter relates to a non-transitory computer-readable medium encoded with executable instructions. The instructions include code to receive a representation of a sequenced graph. The representation includes a set of graph components, where each graph component is associated with at least one sequence counter from among multiple sequence counters. The instructions include code to generate, for each sequence counter from among the multiple sequence counters, a graph visualization, where the graph visualization for a specific sequence counter includes graph components associated with the specific sequence counter, and where the graph visualization for the specific sequence counter blurs, obfuscates, or lacks graph components not associated with the specific sequence counter. The instructions include code to store the generated graph visualization for each sequence counter from among the multiple sequence counters.

In some aspects, the disclosed subject matter relates to a system. The system includes processing hardware and a memory including instructions. The instructions include code to receive a representation of a sequenced graph. The representation includes a set of graph components, where each graph component is associated with at least one sequence counter from among multiple sequence counters. The instructions include code to generate, for each sequence counter from among the multiple sequence counters, a graph visualization, where the graph visualization for a specific sequence counter includes graph components associated with the specific sequence counter, and where the graph visualization for the specific sequence counter blurs, obfuscates, or lacks graph components not associated with the specific sequence counter. The instructions include code to store the generated graph visualization for each sequence counter from among the multiple sequence counters.

Other configurations of the subject technology will become readily apparent from the following detailed description, where various configurations of the subject technology are shown and described by way of illustration. The subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1A illustrates a first example annotated graph for a sequenced graph visualization.

FIG. 1B illustrates an example visualization of the first example annotated graph of FIG. 1A for stage 1.

FIG. 1C illustrates an example visualization of the first example annotated graph of FIG. 1A for stage 2.

FIG. 1D illustrates an example visualization of the first example annotated graph of FIG. 1A for stage 3.

FIG. 1E illustrates an example visualization of the first example annotated graph of FIG. 1A for stage 4.

FIG. 1F illustrates an example visualization of the first example annotated graph of FIG. 1A for stage 5.

FIG. 2A illustrates a second example annotated graph for a sequenced graph visualization.

FIG. 2B illustrates an example visualization of the second example annotated graph of FIG. 2A for stage 1.

FIG. 2C illustrates an example visualization of the second example annotated graph of FIG. 2A for stage 2.

FIG. 2 illustrates an example visualization of the second example annotated graph of FIG. 2A for stage 3.

FIG. 2E illustrates an example visualization of the second example annotated graph of FIG. 2A for stage 4.

FIG. 2F illustrates an example visualization of the second example annotated graph of FIG. 2A for stage 5.

FIG. 2G illustrates an example visualization of the second example annotated graph of FIG. 2A for stage 6.

FIG. 3 illustrates an example of a computing device for generating a sequenced graph visualization.

FIG. 4 illustrates an example process by which a sequenced graph visualization may be generated.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, certain structures and components are shown in block diagram form in order to avoid obscuring the concepts of the subject technology.

As set forth above, a slideshow application may allow a user to design multiple slides, where each slide includes different content. Similarly, a graphing or computer-aided design (CAD) application may allow the user to design multiple graphs or charts, where each graph or chart includes different content. However, the slideshow, graphing, or CAD applications may not be useful for designing or presenting certain types of graphs.

For instance, in some cases, the user may wish to develop a sequenced graph that displays different but related information on the same graph in different pages or slides of the graph. For example, the first slide of a multi-slide graph may include a single node displaying a man. The second slide may include the node displaying the man, an additional node displaying the man's wife, and an edge between the man's node and the man's wife's node. The third slide may include the node displaying the man, the node displaying the man's wife, and a node displaying a child of the man and the man's wife. Edges could be presented between the man's node and the man's wife's node, between the man's node and the child's node, and between the man's wife's node and the child's node.

Using the slideshow, graphing, or CAD applications described above, the user may be compelled to create three slides or three pages to present the three graphs described above, requiring a repetition of the user's efforts and wasting the user's time (e.g., the user may need to draw the node for the man three times or use copying and pasting techniques). Also, memory can be wasted as image or visualization data associated with copied nodes (e.g., the node for the man) are stored in multiple copies. In some graphing applications, the user can insert an explicit instruction to show or hide a specific item and use a combination of these show/hide instructions to emulate a sequenced presentation. This approach however is highly tedious because these show/hide instructions are, in some cases, explicitly inserted for all of the graph items. In contrast, in the approach of some examples of the subject technology, such instructions may automatically be inferred from the sequence counters. In this latter approach, the user may think about the overall sequence of the graph the user is constructing as opposed to the multitude of animation instructions that would be required to visually achieve such a sequence. As the foregoing illustrates, a new approach for generating or storing a sequenced graph visualization may be desirable.

The subject technology, according to some implementations, provides techniques for generating or storing sequenced graph(s) or sequenced graph visualization(s). According to some examples, a computing device receives (e.g., from a user operating a keyboard, a mouse, and/or a touch screen) a representation of a sequenced graph. The representation includes a set of graph components (e.g., node(s) or edge(s)). Each graph component is associated with at least one sequence number (e.g., a range of sequence numbers, multiple ranges of sequence numbers, a single sequence number, or multiple single sequence numbers) from among a multiple sequence numbers. For example, in the sequenced graph with the man, the man's wife, and the child described above, the multiple sequence numbers can include 1, 2, and 3. The node for the man can be associated with the range of sequence numbers 1-3. The node for the man's wife can be associated with the range of sequence numbers 2-3. The node for the child can be associated with the sequence number 3.

The computing device generates, for each sequence number from among the multiple sequence numbers, a graph visualization. The graph visualization for a specific sequence number includes graph components associated with the specific sequence number. The graph visualization for the specific sequence number blurs, obfuscates, or lacks graph components not associated with the specific sequence number. For example, in the sequenced graph with the man, the man's wife, and the child described above, the node for the man is associated with the sequence number 1 and the node for the man's wife is not associated with the sequence number 1. Thus, in the graph visualization for sequence number 1, the node for the man will be included and the node for the man's wife will be blurred, obfuscated, or not included. The generated graph visualization for each sequence number from among the multiple sequence numbers is stored in a memory.

While some implementations of the subject technology are described herein with reference to a “sequence number” for ease of understanding, any sequence counter can be used in place of the sequence number. For example, the sequence counter can include a numeric counter (e.g., 1, 2, 3, . . . ), an alphabetic counter (e.g., A, B, C, . . . ), a counter that iterates through a list of ordered strings (e.g., foo, bar, baz, . . . ), an alphanumeric counter (e.g., 1A, 1B, 1C, 2A, 2B, 2C, . . . ), or any kind of mechanism that contains a sequence of stages.

As used herein, the phrase “sequenced graph” encompasses its plain and ordinary meaning including, but not limited to, a graph that includes multiple visualizations, where each visualization is associated with a sequence counter. In some implementation, the sequenced graph includes graph component(s), where each graph component is displayed in at least one visualization associated with a sequence counter. Some graph component(s) can be displayed at two or more graph visualization(s). Examples of sequenced graphs are described herein in conjunction with FIGS. 1A-1F and FIGS. 2A-2G.

As used herein, the phrase “processing hardware” encompasses its plain and ordinary meaning including, but not limited to, one or more processors, a central processing unit (CPU), a graphics processing unit (GPU), or any other processing unit. In some implementations, processing hardware can include multiple of the above units, for example, both a CPU and a GPU.

FIG. 1A illustrates a first example annotated graph 100A for a sequenced graph visualization.

The annotated graph 100A can correspond to a user input for a graphing application configured to generate sequenced graphs. As shown, the annotated graph 100A includes a first node 110A, a second node 120A, a third node 130A, a container 140A, and edges 112A, 122A, 124A, and 132A. The container 140A includes inside node 142A, inside circle node 146A, and edge 144A.

The first node 110A includes the indication “{1, 2=@T}”. The number 1 indicates that the first node is to be presented when the sequence number is greater than or equal to 1. The indication “2=@T” indicates that, when the sequence number is greater than or equal to 2, the first node 110A should be changed to a triangle (“T”).

The second node 120A includes the indication {2}, indicating that the second node 120A is to be presented when the sequence number is greater than or equal to 2.

The third node 130A includes the indication {3}, indicating that the second node 120A is to be presented when the sequence number is greater than or equal to 3.

As shown, the container 140A include the indication {4}, indicating that the container is to be presented when the sequence number is greater than or equal to 4. According to some implementations, the container 140A may be shown if the sequence number is within the set of sequence numbers when the container is to be shown and at least one graph component inside the container—the inside node 142A, the edge 144A, or the inside circle node 146A—is also shown. A graph component 142A, 144A, or 146A inside the container 140A may be shown only when the container is shown and the sequence number is within the set of sequence numbers for which the graph component 142A, 144A, or 146A is shown. For example, if container 140A is indicated to be shown when the sequence number is greater than or equal to 4, and the inside node 142A is indicated to be shown when the sequence number is greater than or equal to 1, the inside node will be shown when both the sequence number is greater than or equal to 4 and the sequence number is greater than or equal to 1.

As shown, each edge 112A, 122A, 124A, 132A, and 144A also includes an indication, in braces, of sequence numbers where the edge 112A, 122A, 124A, 132A, or 144A is to be presented. For example, specific data edge 124A is indicated to be presented at sequence number 3-4, meaning sequence numbers greater than or equal to 3 and less than 4. According to some examples, the edge 112A, 122A, 124A, 132A, or 144A that connects two other graph components may be presented at sequence numbers where the edge 112A, 122A, 124A, 132A, or 144A is indicated to be presented and the two connected graph components are both presented. For example, edge 132A is indicated to be presented when the sequence number is greater than or equal to 1. However, the edge 132A connects the third node 130, which is presented when the sequence number is greater than or equal to 3, with the container 140, which is presented when the sequence number is greater than or equal to 4. Thus, edge 132A will be presented when the sequence number is greater or equal to than 4, but not when the sequence number is less than 4, as at least one of the components connected by the edge 132A is not presented at sequence numbers less than 4.

FIG. 1A illustrates one approach for indicating sequence number(s) where graph component(s) are to be presented or sequence number(s) where an icon (e.g., square or triangle) associated with a graph component is to be changed. However, other approaches for indicating this information can be developed and are within the scope of the subject technology.

FIG. 1B illustrates an example visualization 100B of the first example annotated graph of FIG. 1A for stage 1 (sequence number=1).

As shown, the visualization 100B includes the first node 110B, which is indicated to be displayed in stage 1.

Edge 112A is also indicated to be displayed in stage 1. However, edge 112A is not displayed because edge 112A connects to second node 120A which is not displayed. Similarly, edge 132A is not displayed because edge 132A connects third node 130A with container 140A, both of which are not displayed. The inside node 142A is not displayed because the inside node 142A is within the container 140A, which is not displayed. The inclusion of the graph components illustrated in FIG. 1B at sequence number=1 is set forth according to the rules specified above.

FIG. 1C illustrates an example visualization 100C of the first example annotated graph of FIG. 1A for stage 2 (sequence number=2).

As shown, the visualization 100C includes the first node 110C, the second node 120C, and the edge 112C between the first node 110C and the second node 120C. Also, in accordance with the instruction {1, 2=@T} at the first node 110A of FIG. 1A, the first node 110C is displayed as a triangle icon, in contrast with the square icon of the first node 110B of FIG. 1B. The inclusion of these graph components at sequence number=2 is set forth according to the rules specified above.

FIG. 1D illustrates an example visualization 100D of the first example annotated graph of FIG. 1A for stage 3 (sequence number=3).

As shown, the visualization 100D includes the first node 110D, presented with a triangle icon, the second node 120D, and the third node 130D. The visualization 100D also includes edge 112D between the first node 110D and the second node 120D, and edge 122D and specific data edge 124D between the second node 120D and the third node 130D. The inclusion of these graph components at sequence number=3 is set forth according to the rules specified above.

FIG. 1E illustrates an example visualization 100E of the first example annotated graph of FIG. 1A for stage 4 (sequence number=4).

As shown, the visualization 100E includes the first node 110E, presented with a triangle icon, the second node 120E, and the third node 130E. The visualization 100E also includes the container 140E, including the inside node 142E. The visualization 100E also includes the edge 112E between the first node 110E and the second node 120E, the edge 122E between the second node 120E and the third node 130E, and the edge 132E between the third node 130E and the container 140E. The inclusion of these graph components at sequence number=4 is set forth according to the rules specified above.

FIG. 1F illustrates an example visualization 100F of the first example annotated graph of FIG. 1A for stage 5 (sequence number=5).

As shown, the visualization 100F includes the first node 100F, presented with a triangle icon, the second node 120F, and the third node 130F. The visualization 100F also includes the container 140F, including the inside node 142F, the inside circle node 146F, and the edge 144F between the inside node 142F and the inside circle node 146F. The visualization 100F includes the edge 112F between the first node 110F and the second node 120F, the edge 122F between the second node 120F and the third node 130F, and the edge 132F between the third node 130F and the fourth node 140F. The inclusion of these graph components at sequence number=5 is set forth according to the rules specified above.

FIG. 2A illustrates a second example annotated graph 200A for a sequenced graph visualization.

The annotated graph 200A can correspond to a user input for a graphing application configured to generate sequenced graphs. As shown, the annotated graph 200A includes a first node 210A, a second node 220A, a third node 230A, a container 240A and edges 212A, 222A, 224A, 226A, and 232A. The container 240A includes inside node 242A, inside circle node 246A, and edge 244A.

The first node 210A includes the indication “{1-2, 2-3=@T, 3-5=@C, First Node Alt} First Node.” This indication means that, when the sequence number is greater than or equal to 1 and less than 2, the first node 210A is to be displayed as illustrated in FIG. 2A, with a square icon and with the text “First Node.” When the sequence number is greater than or equal to 2 and less than 3, the first node 210A is to be displayed with a triangle (“T”) icon instead of a square icon. When the sequence number is greater than or equal to 3 and less than 5, the first node 210A is to be displayed with a circle (“C”) icon instead of a square icon and with the text “First Node Alt,” instead of “First Node.” For other values of the sequence number (e.g., when the sequence number is greater than or equal to 5), the first node 210A is not to be displayed, or the first node is to be blurred or obfuscated.

The second node 220A includes the indication “{2},” indicating that the second node is to be displayed when the sequence number is greater than or equal to 2. For other values of the sequence number, the second node 220A is not to be displayed or is to be blurred or obfuscated.

The third node 230A includes the indication “{3-4, 4-6=Third Node Alt, 6=Alt2}Third Node.” This indication means that, when the sequence number is greater than or equal to 3 and less than 4, the third node 230A is to be displayed as shown in FIG. 2A. When the sequence number is greater than or equal to 4 and less than 6, the third node 230A is to be displayed with the text “Third Node Alt,” instead of “Third Node.” When the sequence number is greater than 6, the third node 230A is to be displayed with the text “Alt2,” instead of “Third Node.”

The edge 212A includes the indication “{1-2, 4-6},” indicating that the edge 212A is to be displayed when the first node 210A and the second node 220A, which are connected by the edge 212A are displayed, and when the sequence number is either greater than or equal to 1 and less than 2 or greater than or equal to 4 and less than 6.

The edge 222A includes the indication “{1},” indicating that the edge 222A is to be displayed when the second node 220A and the third node 230A connected by the edge 222A are displayed and when the sequence number is greater than or equal to 1.

The specific data edge 224A includes the indication “{3-4},” indicating that the specific data edge 224A is to be displayed when the second node 220A and the third node 230A connected by the specific data edge 224A are displayed and when the sequence number is greater than or equal to 3 and less than 4.

The another edge 226A includes the indication “{6},” indicating that the another edge 226A is to be displayed when the second node 220A and the container 240A are displayed and when the sequence number is greater than or equal to 6.

The edge 232A includes the indication “{1},” indicating that the edge 232A is to be displayed when the third node 230A and the container 240A are displayed and when the sequence number is greater than or equal to 1.

The container 240A includes the graph components 242A, 244A, and 246A. The container 240A includes the indication “{4},” indicating that the container 240A is to be displayed whenever at least one of the graph components 242A, 244A, or 246A is displayed and the sequence number is greater than or equal to 4. As shown, the container 240A will be displayed whenever the sequence number is greater than or equal to 4, as the inside node 242A is indicated to be displayed whenever the sequence number is greater than or equal to 1 (“{1}”).

The inside node 242A includes the indication “{1},” indicating that the inside node 242A is to be displayed whenever the container 240A is displayed and the sequence number is greater than or equal to 1. As shown, the inside node 242A will be displayed whenever the sequence number is greater than or equal to 4, due to the indication of the container 240A.

The inside circle node 246A includes the indication “{5},” indicating that the inside circle node 246A is to be displayed whenever the container 240A is displayed and the sequence number is greater than or equal to 5.

The edge 244A lacks an indication (in braces). Thus, the edge 244A is to be displayed whenever the container 240A, which contains the edge 244A, is displayed, and whenever the nodes 242A and 246A connected by the edge 244A are displayed. As illustrated, the edge 244A is to be displayed whenever the sequence number is greater than or equal to 5.

In some implementations, a range of sequence numbers for which to generate graph visualizations (e.g., 1-6) is specified by the user. In some implementations, the range of sequence numbers is automatically determined by a computing device implementing the graphing application.

In some implementations, the sequence counter(s) of the graph component(s) are specified by the user. In some implementations, the sequence counter(s) of the graph component(s) are automatically determined by a computing device.

As illustrated in FIGS. 2A-2G, the sequence numbers start at 1 and increase one integer at a time until there are no longer any changes. With an input as shown in FIG. 2A, graphs visualizations can be generated for sequence numbers 1-6, with no further changes after sequence number 6, as the input as shown in FIG. 2A does not indicate that the annotated graph 200A changes after sequence number=6. Thus, in some cases, based on an input corresponding to the annotated graph 200A, the computer receiving the input can automatically conclude that graph visualizations should be generated for sequence numbers 1-6 (e.g., only sequence numbers 1-6 or sequence numbers 1-6 and other sequence number(s)).

FIG. 2B illustrates an example visualization 200B of the second example annotated graph of FIG. 2A for stage 1 (sequence number=1).

As shown, the visualization 200B includes the graph component 210B. The inclusion of this graph components at sequence number=1 is set forth according to the rules specified above.

FIG. 2C illustrates an example visualization 200C of the second example annotated graph of FIG. 2A for stage 2 (sequence number=2).

As shown, the visualization 200C includes the graph components 210C, 212C, and 220C. The inclusion of these graph components at sequence number=2 is set forth according to the rules specified above. The first node 210C is displayed with a triangle icon, rather than with a square icon, as shown at the first node 210B of FIG. 2B.

FIG. 2D illustrates an example visualization 200D of the second example annotated graph of FIG. 2A for stage 3 (sequence number=3).

As shown, the visualization 200D includes the graph components 210D, 220D, 222D, 224D, and 230D. The inclusion of these graph components at sequence number=3 is set forth according to the rules specified above. In accordance with the indication described in conjunction with FIG. 2A, the first node 210D is displayed with a circle icon, rather than with a square icon, as shown at the first node 210B of FIG. 2B, or with a triangle icon, as shown at the first node 210C of FIG. 2C. Also, the text of the first node 210D reads “First Node Alt,” rather than “First Node,” as at the first node 210B of FIG. 2B or at the first node 210C of FIG. 2C.

FIG. 2E illustrates an example visualization 200E of the second example annotated graph of FIG. 2A for stage 4 (sequence number=4).

As shown, the visualization 200E includes the graph components 210E, 212E, 220E, 222E, 230E, 232E, 240E, and 242E. The inclusion of these graph components at sequence number=4 is set forth according to the rules specified above. In accordance with the indication described in conjunction with FIG. 2A, the first node 210E is displayed with a circle icon, rather than with a square icon, as shown at the first node 210B of FIG. 2B, or with a triangle icon, as shown at the first node 210C of FIG. 2C. Also, the text of the first node 210E reads “First Node Alt,” rather than “First Node,” as at the first node 210B of FIG. 2B or at the first node 210C of FIG. 2C. Also in accordance with the indication described in conjunction with FIG. 2A, the text of the third node 230E reads “Third Node Alt,” rather than “Third Node,” as at the third node 230D of FIG. 2D.

FIG. 2F illustrates an example visualization 200F of the second example annotated graph of FIG. 2A for stage 5 (sequence number=5).

As shown, the visualization 200F includes the graph components 220F, 222F, 230F, 232F, 240F, 242F, 244F, and 246F. The inclusion of these graph components at sequence number=5 is set forth according to the rules specified above. In accordance with the indication described in conjunction with FIG. 2A, the text of the third node 230F reads “Third Node Alt,” rather than “Third Node,” as at the third node 230D of FIG. 2D.

FIG. 2G illustrates an example visualization 200G of the second example annotated graph of FIG. 2A for stage 6 (sequence number=6).

As shown, the visualization 200G includes the graph components 220G, 222G, 224G, 226G, 230G, 232G, 240G, 242G, 244G, and 246G. The inclusion of these graph components at sequence number=6 is set forth according to the rules specified above. In accordance with the indication described in conjunction with FIG. 2A, the text of the third node 230G reads “Alt2,” rather than “Third Node,” as at the third node 230D of FIG. 2D, or “Third Node Alt,” as at the third node 230E of FIG. 2E or the third node 230F of FIG. 2F.

FIG. 3 illustrates an example of a computing device 300 for generating a sequenced graph visualization (e.g., one or more of the visualizations 100B, 100C, 100D, 100E, 100F, 200B, 200C, 200D, 200E, 200F, or 200G).

The computing device 300 may be a laptop computer, a desktop computer, a mobile phone, a personal digital assistant (PDA), a personal digital music player, a tablet computer, a netbook, a television with one or more processors embedded therein or coupled thereto, a physical machine, or a virtual machine. While the computing device 300 is illustrated herein as a user device with local input/output device(s), the computing device 300 can be a server that is accessed by a remote user using a web browser or a special purpose application at a remote device. Also, while the computing device 300 is illustrated herein as being a single computing device, in some implementations, the component(s) of the computing device 300 may reside on multiple different computing devices or the computing device 300 may include multiple different computing devices.

As shown, the computing device 300 includes a central processing unit (CPU) 302, a network interface 304, input/output device(s) 306, and a memory 308. The CPU 302 includes one or more processors. The CPU 302 is configured to execute computer instructions that are stored in a computer-readable medium, for example, the memory 308. While the computing device 300 is illustrated as including the CPU 302, in some implementations, the computing device 300 can include any other processing hardware in place of or in addition to the CPU 302. The network interface 304 is configured to allow the computing device 300 to transmit and receive data in a network, e.g., a wired network, a wireless network, a local area network (LAN), a wide area network (WAN), the Internet, an intranet, a virtual private network (VPN), etc. The network interface 304 may include one or more network interface cards (NICs). The input/output device(s) 306 can include one or more of a keyboard, a mouse, a touch screen, or a non-touch display device. The input/output device(s) 306 are configured to allow a user to interface with the computing device 300. While the input/output device(s) 306 are illustrated as being components of the computing device, the input/output device(s) 306 can reside externally to the computing device 300 and be coupled with the computing device 300 via a port (e.g., a universal serial bus (USB) port or a video port) or a radio connection (e.g., a Bluetooth connection). The memory 308 stores data and/or instructions. The memory 308 may be one or more of a cache unit, a storage unit, an internal memory unit, or an external memory unit. As illustrated, the memory 308 includes a graphing application 310.

The graphing application 310 is configured to receive an input for generating one or more graphs and to generate the one or more graphs based on the received input. As shown, the graphing application 310 includes a sequenced graph visualization module 312 and sequenced graphs 314.1-2. While two sequenced graphs 314.1-2 are illustrated herein, the computing device may store any number of sequenced graphs 314.k (limited by a size of the memory 308 of the computing device 300).

The sequenced graph 314.1 can be generated based on an annotated graph input as shown, for example, in annotated graph 100A of FIG. 1A or annotated graph 100B of FIG. 1B. The sequenced graph 314.1 includes generated graph visualization(s) 316.1.1-n. Each generated graph visualization 316.1.k (where k is a number between 1 and n) corresponds to a sequence counter (e.g., a sequence number). For example, if the sequenced graph 314.1 corresponds to the annotated graph 100A, the generated graph visualization(s) 316.1.1-n can include the visualizations 100B, 100C, 100D, 100E, and/or 100F. The sequenced graph 314.2 is a data structure similar that representing the sequenced graph 314.1 and, similarly, includes generated graph visualization(s) 316.2.1-n. For example, if the sequenced graph 314.2 corresponds to the annotated graph 200A, the generated graph visualization(s) 316.2.1-n can include the visualizations 200B, 200C, 200D, 200E, 200F, and/or 200G.

The sequenced graph visualization module 312 includes code to receive a representation of a sequenced graph (e.g., annotated graph 100A or a representation of the sequenced graph 314.1). The received representation includes a set of graph components. Each graph component is associated with at least one sequence counter (e.g., a sequence number or another counter, e.g., an alphabetic counter) from among multiple sequence counters. The sequenced graph visualization module 312 includes code to generate, for each sequence counter from among the multiple sequence counters, a graph visualization (e.g., graph visualization 100B for sequence number=1, graph visualization 100C for sequence number=2, etc., which may correspond to the generated graph visualization(s) 316.1.1-n). The graph visualization for a specific sequence counter includes graph components associated with the specific sequence counter. The graph visualization for a specific sequence counter blurs, obfuscates, or lacks graph components not associated with the specific sequence counter. The sequenced graph visualization module includes code to store, in the memory 308 or another memory unit, the generated graph visualization (e.g. generated graph visualization(s) 316.1.-n) for each sequence counter from among the multiple sequence counters. While the sequenced graph visualization module 312 is described here as being implemented in software, the sequenced graph visualization module 312 may, in some cases, be implemented in hardware or in a combination of software and hardware.

FIG. 4 illustrates an example process 400 by which a sequenced graph visualization may be generated.

The process 400 begins at step 410, where a computing device (e.g., computing device 300, via operation of the sequenced graph visualization module 312) receives a representation of a sequenced graph (e.g., annotated graph 200A). The representation includes a set of graph components (e.g., graph components 210A, 212A, 220A, 222A, 224A, 226A, 230A, 232A, 242A, 244A, and 246A). Each graph component is associated with at least one sequence counter (e.g., a sequence number, a range of sequence numbers, or a non-numeric sequence counter) from among multiple sequence counters (e.g., sequence numbers 1 through 6 for annotated graph 200A). In some implementations, at least one graph component (e.g., graph component 220A) is not associated with at least one sequence number (e.g., sequence number=1, as illustrated in visualization 200B of FIG. 2B). The representation of the sequenced graph may be input to the computing device by a user of the computing device through the input/output device(s) of the computing device (e.g., input/output devices 306). Alternatively, the computing device may load, from a data repository (e.g., the memory 308 of the computing device 300 or an external data storage unit) the representation of the sequenced graph. The received representation of the sequenced graph may be a single page representation that is received in a single page of an application (e.g., annotated graph 200A is shown in a single page).

In step 420, the computing device generates, for each sequence counter from among the multiple sequence counters, a graph visualization (e.g., visualization 200B for sequence number=1, visualization 200C for sequence number=2, etc.). The graph visualization for a specific sequence counter (e.g., sequence number=2) includes graph components associated with the specific sequence counter (e.g., graph components 210C, 212C, and 220C are included in visualization 200C for sequence number=2). The graph visualization for the specific sequence counter blurs, obfuscates, or lacks graph components not associated with the specific sequence counter (e.g., graph components 222A, 224A. 226A 230A, 232A, 242A, 244A, and 246A, are blurred, obfuscated, or lacking from the visualization 200C for sequence number=2). The generated graph visualization can be a generated graph image. The generated graph image can be an image file (e.g., a JPEG file) or an image displayed via a display device (e.g., a screen).

In some examples, the graph components include a set of nodes and a set of edges. Each node in the set of nodes is associated with at least one sequence counter. Each edge in the set of edges is associated with at least two nodes from the set of nodes and at least one sequence counter. The computing device can determine, for a specific sequence counter associated with a specific edge, whether the specific sequence counter is associated with each of the two nodes associated with the specific edge. The computing device can place the specific edge in the graph visualization for the specific sequence counter in a case where the specific sequence counter is associated with each of the two nodes associated with the specific edge. The computing device can blur, obfuscate, or forego placing the specific edge in the graph visualization for the specific sequence counter in a case where the specific sequence counter is not associated with at least one of the two nodes associated with the specific edge.

In some examples, the set of graph components includes a displayed container unit (e.g., container 240A). The displayed container unit includes, within the displayed container unit, a subset of the set of graph components (e.g., graph components 242A, 244A, and 246A). The computing device can determine, for a specific sequence counter associated with the displayed container unit, whether the specific sequence counter is associated with at least one graph component within the subset of the set of graph components. The computing device can place the displayed container unit in the graph visualization for the specific sequence counter in a case where the specific sequence counter is associate with at least one graph component within the subset. The computing device can blur, obfuscate, or forego placing the displayed container unit in the graph visualization for the specific sequence counter in a case where the specific sequence counter is not associated with at least one graph component within the subset.

A graph component (e.g., a node) can be associated with a first icon (e.g., a square) for a first sequence counter and a second icon (e.g., a triangle) for a second sequence counter. The graph component may be represented using the first icon in the graph visualization at the first sequence counter and the second icon in the graph visualization at the second sequence counter. The graph component may be associated with n different icons for n different sequence counter values or sequence counter ranges, where n is any positive integer.

A graph component (e.g., a node) can be associated with a first text (e.g., “John Doe”) for a first sequence counter and a second text (e.g., “John Doe, Deceased”) for a second sequence counter. The graph component may be represented with the first text in the graph visualization at the first sequence counter and the second text in the graph visualization at the second sequence counter. The graph component may be associated with n different texts for n different sequence counter values or sequence counter ranges, where n is any positive integer. The n different texts may differ from one another in terms of the content, font, style, size, or color. For example, one of the n different texts may be “John Doe” written in Times New Roman size 12 font and another of the n different texts may be “John Doe” written in Courier New size 10 font with bold letters.

In step 430, the computing device stores, in a memory (e.g., the memory 308 of the computing device 300 or a memory unit external to the computing device 300), the generated graph visualization (e.g., the generated graph visualizations 316.2.1-n for the sequenced graph 314.2 are stored in the memory 308) for each sequence counter from among the multiple sequence counters. In some implementations, the computing device may provide for display of the generated graph visualization for at least a portion of the sequence counters from among the multiple sequence counters. (E.g., The visualization(s) 200B, 200C, 200D, 200E, 200F, and/or 200G can be displayed via a display device (e.g., a screen) of the computing device 300 or coupled to the computing device 300.) It should be noted that the computing device may provide for display the visualization(s) for some sequence counter(s) and blur, obfuscate, or forego providing for display the visualization(s) for other sequence counter(s). (E.g., visualization 200B can be provided for display, while visualization 200G is blurred, obfuscated, or not provided for display.) After step 430, the process 400 ends.

In some implementations, instructions for implementing the steps 410-430 in the process 400 may be stored in a memory of a computing device and may be carried out by one or more computing devices. The steps 410-430 in the process 400 may be carried out in series. Alternatively, two or more of the steps 410-430 in the process 400 may be carried out in parallel.

FIG. 5 conceptually illustrates an electronic system 500 with which some implementations of the subject technology are implemented. For example, the computing device 300 may be implemented using the arrangement of the electronic system 500. The electronic system 500 can be a computer (e.g., a mobile phone, PDA), or any other sort of electronic device. Such an electronic system includes various types of computer readable media and interfaces for various other types of computer readable media. Electronic system 500 includes a bus 505, processing unit(s) 510, a system memory 515, a read-only memory 520, a permanent storage device 525, an input device interface 530, an output device interface 535, and a network interface 540.

The bus 505 collectively represents all system, peripheral, and chipset buses that communicatively connect the numerous internal devices of the electronic system 500. For instance, the bus 505 communicatively connects the processing unit(s) 510 with the read-only memory 520, the system memory 515, and the permanent storage device 525.

From these various memory units, the processing unit(s) 510 retrieves instructions to execute and data to process in order to execute the processes of the subject technology. The processing unit(s) can be a single processor or a multi-core processor in different implementations.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some implementations of the subject technology use a mass-storage device (for example a magnetic or optical disk and its corresponding disk drive) as the permanent storage device 525.

Other implementations use a removable storage device (for example a floppy disk, flash drive, and its corresponding disk drive) as the permanent storage device 525. Like the permanent storage device 525, the system memory 515 is a read-and-write memory device. However, unlike storage device 525, the system memory 515 is a volatile read-and-write memory, such a random access memory. The system memory 515 stores some of the instructions and data that the processor needs at runtime. In some implementations, the processes of the subject technology are stored in the system memory 515, the permanent storage device 525, or the read-only memory 520. For example, the various memory units include instructions for generating, storing, or providing for display of a sequenced graph visualization in accordance with some implementations. From these various memory units, the processing unit(s) 510 retrieves instructions to execute and data to process in order to execute the processes of some implementations.

The bus 505 also connects to the input and output device interfaces 530 and 535. The input device interface 530 enables the user to communicate information and select commands to the electronic system. Input devices used with input device interface 530 include, for example, alphanumeric keyboards and pointing devices (also called “cursor control devices”). Output device interfaces 535 enables, for example, the display of images generated by the electronic system 500. Output devices used with output device interface 535 include, for example, printers and display devices, for example cathode ray tubes (CRT) or liquid crystal displays (LCD). Some implementations include devices for example a touch screen that functions as both input and output devices.

Finally, as shown in FIG. 5, bus 505 also couples electronic system 500 to a network (not shown) through a network interface 540. In this manner, the electronic system 500 can be a part of a network of computers (for example a local area network (“LAN”), a wide area network (“WAN”), or an Intranet, or a network of networks, for example the Internet. Any or all components of electronic system 500 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A computer-implemented method for generating a sequenced graph visualization, the method comprising:
receiving a representation of a sequenced graph, the representation comprising a set of graph components, wherein each graph component is associated with at least one sequence counter from among a plurality of sequence counters;
generating, for each sequence counter from among the plurality of sequence counters, a graph visualization, wherein the graph visualization for a specific sequence counter comprises graph components associated with the specific sequence counter, and wherein the graph visualization for the specific sequence counter blurs, obfuscates, or lacks graph components not associated with the specific sequence counter; and
storing, in a memory, the generated graph visualization for each sequence counter from among the plurality of sequence counters.

2. The method of claim 1, wherein at least a first graph component is not associated with at least a first sequence counter from among the plurality of sequence counters.

3. The method of claim 1, further comprising:
providing for display of the generated graph visualization for at least a portion of the sequence counters from among the plurality of sequence counters.

4. The method of claim 3, further comprising:
blurring, obfuscating, or foregoing providing for display the generated graph visualization for at least an additional portion of sequence counters from among the plurality of sequence counters.

5. The method of claim 1, wherein the set of graph components comprises a set of nodes and a set of edges, wherein each node in the set of nodes is associated with at least one sequence counter, and wherein each edge in the set of edges is associated with at least two nodes from the set of nodes and at least one sequence counter, the method further comprising:
determining, for a specific sequence counter associated with a specific edge, whether the specific sequence counter is associated with each of the at least two nodes associated with the specific edge;
placing the specific edge in the graph visualization for the specific sequence counter in a case where the specific sequence counter is associated with each of the at least two nodes associated with the specific edge; and
blurring, obfuscating, or foregoing placing the specific edge in the graph visualization for the specific sequence counter in a case where the specific sequence counter is not associated with at least one of the at least two nodes associated with the specific edge.

6. The method of claim 1, wherein the set of graph components comprises a displayed container unit, the displayed container unit comprising, within the displayed container unit, a subset of the set of graph components, the method further comprising:
determining, for a specific sequence counter associated with the displayed container unit, whether the specific sequence counter is associated with at least one graph component within the subset of the set of graph components;
placing the displayed container unit in the graph visualization for the specific sequence counter in a case where the specific sequence counter is associated with the at least one graph component within the subset; and
blurring, obfuscating, or foregoing placing the displayed container unit in the graph visualization for the specific sequence counter in a case where the specific sequence counter is not associated with the at least one graph component within the subset.

7. The method of claim 1, wherein a first graph component is associated with at least a first sequence counter and at least a second sequence counter from among the plurality of sequence counters, wherein the first graph component is associated with a first icon at the at least the first sequence counter, wherein the first graph component is associated with a second icon at the at least the second sequence counter, the method further comprising:
representing, in the graph visualization for the at least the first sequence counter, the first graph component using the first icon; and
representing, in the graph visualization for the at least the second sequence counter, the first graph component using the second icon, wherein the second icon is different from the first icon.

8. The method of claim 1, wherein a first graph component is associated with at least a first sequence counter and at least a second sequence counter from among the plurality of sequence counters, wherein the first graph component is associated with a first text at the at least the first sequence counter, wherein the first graph component is associated with a second text at the at least the second sequence counter, the method further comprising:
representing, in the graph visualization for the at least the first sequence counter, the first graph component in conjunction with the first text; and
representing, in the graph visualization for the at least the second sequence counter, the first graph component in conjunction with the second text.

9. The method of claim 8, wherein the first text is different from the second text.

10. The method of claim 8, wherein the first text is written in a different font, a different style, or a different color than the second text.

11. The method of claim 1, wherein receiving the representation of the sequenced graph comprises:
receiving, from a user, an input corresponding to the sequenced graph.

12. The method of claim 1, wherein receiving the representation of the sequenced graph comprises:
loading, from a data repository, the representation of the sequenced graph.

13. The method of claim 1, wherein the at least one sequence counter from among the plurality of sequence counters associated with each graph component comprises a range of sequence counters from among the plurality of sequence counters.

14. The method of claim 1, wherein the generated graph visualization comprises a generated graph image.

15. The method of claim 1, wherein the plurality of sequence counters comprise a plurality of sequence numbers.

16. The method of claim 1, wherein receiving the representation of the sequenced graph comprises:
receiving, in a single page, the representation of the sequenced graph.

17. A non-transitory computer-readable medium comprising instructions for generating a sequenced graph visualization, the instructions comprising code to:
receive a representation of a sequenced graph, the representation comprising a set of graph components, wherein each graph component is associated with at least one sequence counter from among a plurality of sequence counters;
generate, for each sequence counter from among the plurality of sequence counters, a graph visualization, wherein the graph visualization for a specific sequence counter comprises graph components associated with the specific sequence counter, and wherein the graph visualization for the specific sequence counter blurs, obfuscates, or lacks graph components not associated with the specific sequence counter; and
store the generated graph visualization for each sequence counter from among the plurality of sequence counters.

18. The computer-readable medium of claim 17, wherein at least a first graph component is not associated with at least a first sequence counter from among the plurality of sequence counters.

19. The computer-readable medium of claim 17, the instructions further comprising code to:
provide for display of the generated graph visualization for at least a portion of the sequence counters from among the plurality of sequence counters.

20. The computer-readable medium of claim 19, the instructions further comprising code to:
blur, obfuscate, or forego providing for display the generated graph visualization for at least an additional portion of sequence counters from among the plurality of sequence counters.

21. The computer-readable medium of claim 17, wherein the set of graph components comprises a set of nodes and a set of edges, wherein each node in the set of nodes is associated with at least one sequence counter, and wherein each edge in the set of edges is associated with at least two nodes from the set of nodes and at least one sequence counter, the instructions further comprising code to:
determine, for a specific sequence counter associated with a specific edge, whether the specific sequence counter is associated with each of the at least two nodes associated with the specific edge;
place the specific edge in the graph visualization for the specific sequence counter in a case where the specific sequence counter is associated with each of the at least two nodes associated with the specific edge; and
blur, obfuscate, or forego placing the specific edge in the graph visualization for the specific sequence counter in a case where the specific sequence counter is not associated with at least one of the at least two nodes associated with the specific edge.

22. The computer-readable medium of claim 17, wherein the set of graph components comprises a displayed container unit, the displayed container unit comprising, within the displayed container unit, a subset of the set of graph components, the instructions further comprising code to:
determine, for a specific sequence counter associated with the displayed container unit, whether the specific sequence counter is associated with at least one graph component within the subset of the set of graph components;
place the displayed container unit in the graph visualization for the specific sequence counter in a case where the specific sequence counter is associated with the at least one graph component within the subset; and
blur, obfuscate, or forego placing the displayed container unit in the graph visualization for the specific sequence counter in a case where the specific sequence counter is not associated with the at least one graph component within the subset.

23. The computer-readable medium of claim 17, wherein a first graph component is associated with at least a first sequence counter and at least a second sequence counter from among the plurality of sequence counters, wherein the first graph component is associated with a first icon at the at least the first sequence counter, wherein the first graph component is associated with a second icon at the at least the second sequence counter, the instructions further comprising code to:
represent, in the graph visualization for the at least the first sequence counter, the first graph component using the first icon; and
represent, in the graph visualization for the at least the second sequence counter, the first graph component using the second icon, wherein the second icon is different from the first icon.

24. The computer-readable medium of claim 17, wherein a first graph component is associated with at least a first sequence counter and at least a second sequence counter from among the plurality of sequence counters, wherein the first graph component is associated with a first text at the at least the first sequence counter, wherein the first graph component is associated with a second text at the at least the second sequence counter, the instructions further comprising code to:
represent, in the graph visualization for the at least the first sequence counter, the first graph component in conjunction with the first text; and
represent, in the graph visualization for the at least the second sequence counter, the first graph component in conjunction with the second text.

25. The computer-readable medium of claim 24, wherein the first text is different from the second text.

26. The computer-readable medium of claim 24, wherein the first text is written in a different font, a different style, or a different color than the second text.

27. The computer-readable medium of claim 17, wherein the code to receive the representation of the sequenced graph comprises code to:
receiving, from a user, an input corresponding to the sequenced graph.

28. The computer-readable medium of claim 17, wherein the code to receive the representation of the sequenced graph comprises code to:
load, from a data repository, the representation of the sequenced graph.

29. The computer-readable medium of claim 17, wherein the at least one sequence counter from among the plurality of sequence counters associated with each graph component comprises a range of sequence counters from among the plurality of sequence counters.

30. The computer-readable medium of claim 17, wherein the generated graph visualization comprises a generated graph image.

31. The computer-readable medium of claim 17, wherein the plurality of sequence counters comprise a plurality of sequence numbers.

32. The computer-readable medium of claim 17, wherein the code to receive the representation of the sequenced graph comprises code to:
receive, in a single page, the representation of the sequenced graph.

33. A system for generating a sequenced graph visualization, the system comprising:
processing hardware; and
a memory comprising instructions which, when executed by the processing hardware, cause the processing hardware to:
receive a representation of a sequenced graph, the representation comprising a set of graph components, wherein each graph component is associated with at least one sequence counter from among a plurality of sequence counters;
generate, for each sequence counter from among the plurality of sequence counters, a graph visualization, wherein the graph visualization for a specific sequence counter comprises graph components associated with the specific sequence counter, and wherein the graph visualization for the specific sequence counter blurs, obfuscates, or lacks graph components not associated with the specific sequence counter; and
store the generated graph visualization for each sequence counter from among the plurality of sequence counters.

34. The system of claim 33, wherein at least a first graph component is not associated with at least a first sequence counter from among the plurality of sequence counters.

35. The system of claim 33, the memory further comprising instructions which, when executed by the processing hardware, cause the processing hardware to:
provide for display of the generated graph visualization for at least a portion of the sequence counters from among the plurality of sequence counters.

36. The system of claim 35, the memory further comprising instructions which, when executed by the processing hardware, cause the processing hardware to:
blur, obfuscate, or forego providing for display the generated graph visualization for at least an additional portion of sequence counters from among the plurality of sequence counters.

37. The system of claim 33, wherein the set of graph components comprises a set of nodes and a set of edges, wherein each node in the set of nodes is associated with at least one sequence counter, and wherein each edge in the set of edges is associated with at least two nodes from the set of nodes and at least one sequence counter, the memory further comprising instructions which, when executed by the processing hardware, cause the processing hardware to:
determine, for a specific sequence counter associated with a specific edge, whether the specific sequence counter is associated with each of the at least two nodes associated with the specific edge;
place the specific edge in the graph visualization for the specific sequence counter in a case where the specific sequence counter is associated with each of the at least two nodes associated with the specific edge; and
blur, obfuscate, or forego placing the specific edge in the graph visualization for the specific sequence counter in a case where the specific sequence counter is not associated with at least one of the at least two nodes associated with the specific edge.

38. The system of claim 33, wherein the set of graph components comprises a displayed container unit, the displayed container unit comprising, within the displayed container unit, a subset of the set of graph components, the memory further comprising instructions which, when executed by the processing hardware, cause the processing hardware to:
determine, for a specific sequence counter associated with the displayed container unit, whether the specific sequence counter is associated with at least one graph component within the subset of the set of graph components;
place the displayed container unit in the graph visualization for the specific sequence counter in a case where the specific sequence counter is associated with the at least one graph component within the subset; and
blur, obfuscate, or forego placing the displayed container unit in the graph visualization for the specific sequence counter in a case where the specific sequence counter is not associated with the at least one graph component within the subset.

39. The system of claim 33, wherein a first graph component is associated with at least a first sequence counter and at least a second sequence counter from among the plurality of sequence counters, wherein the first graph component is associated with a first icon at the at least the first sequence counter, wherein the first graph component is associated with a second icon at the at least the second sequence counter, the memory further comprising instructions which, when executed by the processing hardware, cause the processing hardware to:
represent, in the graph visualization for the at least the first sequence counter, the first graph component using the first icon; and
represent, in the graph visualization for the at least the second sequence counter, the first graph component us ing the second icon, wherein the second icon is different from the first icon.

40. The system of claim 33, wherein a first graph component is associated with at least a first sequence counter and at least a second sequence counter from among the plurality of sequence counters, wherein the first graph component is associated with a first text at the at least the first sequence counter, wherein the first graph component is associated with a second text at the at least the second sequence counter, the memory further comprising instructions which, when executed by the processing hardware, cause the processing hardware to:
represent, in the graph visualization for the at least the first sequence counter, the first graph component in conjunction with the first text; and
represent, in the graph visualization for the at least the second sequence counter, the first graph component in conjunction with the second text.

41. The system of claim 40, wherein the first text is different from the second text.

42. The system of claim 40, wherein the first text is written in a different font, a different style, or a different color than the second text.

43. The system of claim 33, wherein the instructions to receive the representation of the sequenced graph comprises instructions to:
receiving, from a user, an input corresponding to the sequenced graph.

44. The system of claim 33, wherein the instructions to receive the representation of the sequenced graph comprises instructions to:
load, from a data repository, the representation of the sequenced graph.

45. The system of claim 33, wherein the at least one sequence counter from among the plurality of sequence counters associated with each graph component comprises a range of sequence counters from among the plurality of sequence counters.

46. The system of claim 33, wherein the generated graph visualization comprises a generated graph image.

47. The system of claim 33, wherein the plurality of sequence counters comprise a plurality of sequence numbers.

48. The system of claim 33, wherein the instructions to receive the representation of the sequenced graph comprise instructions to:
receive, in a single page, the representation of the sequenced graph.
